(19) United States
(12) Patent Application Publication
(10) Pub. No.: US 2024/0163677 A1
(43) Pub. Date: May 16, 2024

(54) METHOD FOR COLLECTING LOCATION INFORMATION, METHOD FOR PROVIDING LOCATION INFORMATION, AND DEVICE FOR EXECUTING SAME

(71) Applicant: Seoul National University R&DB Foundation, Seoul (KR)

(72) Inventors: Kyu Seok Shim, Seoul (KR); Dae Young Hong, Seoul (KR); Woo Hwan Jung, Seoul (KR)

(21) Appl. No.: 18/281,644

(22) PCT Filed: Nov. 27, 2021
(86) PCT No.: PCT/KR2021/016906

§ 371 Date: Sep. 12, 2023

(30) Foreign Application Priority Data
Apr. 19, 2021 (KR) 10-2021-0050628
Oct. 27, 2021 (KR) 10-2021-0144829

(51) Int. Cl. H04W 12/63

(52) U.S. Cl. CPC H04W 12/63

(57) ABSTRACT

Disclosed is a server for collecting geospatial information. The server may include: one or more server processors determining a domain region for an original location of a terminal, and defining a reference probability for sampling a perturbed location in the domain region according to a relationship between a reference region in the domain region and the perturbed location for the original location. As a result, geospatial information having high reliability may be collected while privacy is protected.

### RELATED APPLICATIONS

This application claims priority to International Patent Application No. PCT/KR2021/016906, filed Nov. 17, 2021, which claims priority to Korean Patent Application No. 10-2021-0050628, filed on Apr. 19, 2021 and Korean Patent Application No. 10-2021-0144829, filed Oct. 27, 2021, the entirety of each of which is incorporated by reference herein.

### TECHNICAL FIELD

The present invention relates to a method and a server for collecting geospatial information for privacy protection, and a method and a terminal for providing geospatial information.

### BACKGROUND ART

Hereinafter, described contents will be only described for the purpose of providing background information related to an embodiment of the present invention, and the described contents are not natural to form the prior art.

A massive amount of user geospatial information is currently collected from smartphones, smartwatches, or the like. The user geospatial information can enhance qualities of personalized services such as advertisements, recommended systems, and web search.

For example, restaurants close to a user are advertised based on a collected location of the user to enhance sales of the relevant restaurants. A market size of domestic geospatial information industry is estimated to be 2.0331 trillion won by 2020. However, since sensitive personal information may leak from the geospatial information, a method for collecting personal geospatial information and protecting privacy is required.

To this end, local differential privacy technology has appeared. The local differential privacy as a reference for privacy protection in which the user autonomously perturbs the personal information with a randomized algorithm without depending on reliability of a data collection server is used for data collection by IT companies such as Google or Apple.

Among geospatial information collection technologies which satisfy the existing local differential privacy, grid-based technologies divide a domain into grids, and then calculate a grid cell to which the location of each user belongs. In addition, in order to satisfy the local differential privacy, the cell to which the user location belongs is randomly changed to another cell at a predetermined probability. However, since the grid-based technologies perturb locations in the same grid cell by the same scheme, an optimized perturbation technique suitable for each location cannot be provided.

Further, in a technology that perturbs the locations by inserting 2D planar Laplace noise without using the grid, perturbation may occur at an infinitely distant location from the domain by inserting unbounded noise, which can cause an unnecessary large error.

Further, piecewise mechanism (PM) which is an existing technology applicable to numerical data can be used for perturbing geospatial data. Unlike the Laplace noise-based scheme, there is a limit in the location which is perturbed with the PM, but the PM is a technology which aims at minimizing an error of an average value of the numerical data, and independently perturbs a value of each dimension of the location, so there is a tendency in which the error of each location perturbed with the PM is large.

Therefore, a technology for collecting the personal geospatial information with higher accuracy and reliability while satisfying the local differential privacy is required.

Meanwhile, the aforementioned prior art as technical information which the inventor(s) possess for deriving the present invention or acquires during a derivation process may not particularly be called known art opened to general public before application of the present invention.

### CITATION LIST

### Patent Literature

U.S. Publication No. US2021/0021957A (Publication date: Jan. 21, 2021)

### DISCLOSURE OF INVENTION

### Technical Problem

An object to be solved by the present invention is to provide a method for collecting geospatial information and a method for providing geospatial information, which enhance a utility of a perturbed location while protecting privacy without depending on a grid.

The objects of the present invention are not limited to the above-mentioned objects, and other objects and advantages of the present invention that are not mentioned can be understood by the following description, and will be more clearly understood by embodiments of the present invention. Further, it will be appreciated that the objects and advantages of the present invention can be realized by means and combinations shown in the claims.

### Solution to Problem

A method for collecting geospatial information according to an embodiment of the present invention may include: determining a domain region for an original location of a terminal; defining a reference probability for sampling a perturbed location in the domain region according to a relationship between a reference region in the domain region and the perturbed location for the original location; deriving an expected value of an error between the original location and the perturbed location based on the reference probability; and determining a region parameter of the reference region so as to minimize the expected value.

A method for providing geospatial information according to an embodiment of the present invention may include: obtaining a region parameter of a reference region within a domain region for an original location of a terminal; determining a center of the reference region so that the reference region is positioned within the domain region based on the original location; and sampling a perturbed location from the domain region or the reference region based on a sampling value determined in a predetermined probability range.

A server for collecting geospatial information according to an embodiment of the present invention may include: one or more server processors determining a domain region for an original location of a terminal, and defining a reference probability for sampling a perturbed location in the domain region according to a relationship between a reference region in the domain region and the perturbed location for the original location.

The server processor may derive an expected value of an error between the original location and the perturbed location based on the reference probability, and determine a region parameter of the reference region so as to minimize the expected value based on the original location.

A terminal for providing geospatial information according to an embodiment of the present invention may include: a terminal communication unit; and one or more terminal processors obtaining a region parameter of a reference region within a domain region for the original location of a terminal from a geospatial information collection server through terminal communication unit, and determining a center of the reference region so that the reference region is positioned within the domain region based on the original location.

The terminal processor may sample a perturbed location from the domain region or the reference region based on a sampling value determined in a predetermined probability range.

Other aspects, features, and advantages other than those described above will become apparent from the following drawings, claims, and detailed descriptions of the invention.

### Advantageous Effects of Invention

According to various embodiments of the present invention, use reliability of a perturbed location corresponding to an original location can be enhanced, and privacy protection can be effectively performed.

The effects of the present invention are not limited to the aforementioned effects, and other objects, which are not mentioned above, will be clearly appreciated by a person having ordinary skill in the art from the following description.

### BRIEF DESCRIPTION OF DRAWINGS

The foregoing and other objects, features, and advantages of the invention, as well as the following detailed description of the embodiments, will be better understood when read in conjunction with the accompanying drawings. For the purpose of illustrating the invention, there is shown in the drawings an exemplary embodiment that is presently preferred, it being understood, however, that the invention is not intended to be limited to the details shown because various modifications and structural changes may be made therein without departing from the spirit of the invention and within the scope and range of equivalents of the claims. The use of the same reference numerals or symbols in different drawings indicates similar or identical items.

FIG. 1 is a diagram for schematically describing a geospatial information collection server which collects a perturbed location corresponding to an original location from a plurality of geospatial information providing terminals according to an embodiment of the present invention;

FIG. 2 is a relative block diagram illustrating a configuration of a geospatial information collection server and a geospatial information providing terminal according to an embodiment of the present invention;

FIG. 3 is a diagram for describing an operation of a geospatial information collection server which determines a domain region and sets a probability density in the domain region according to an embodiment of the present invention;

FIG. 4 illustrates an algorithm for describing a geospatial information providing terminal which samples a perturbed location based on an original location according to an embodiment of the present invention;

FIG. 5 is a sequence diagram illustrating a geospatial information collection method of a geospatial information collection server according to an embodiment of the present invention; and

FIG. 6 is a sequence diagram illustrating a geospatial information providing method of a geospatial information providing terminal according to an embodiment of the present invention.

### MODE(S) FOR CARRYING OUT THE INVENTION

Hereinafter, the present invention will be described in more detail with reference to the drawings. The present invention may be implemented in various different forms and is not limited to exemplary embodiments described herein. Hereinafter, in the embodiment, in order to clearly describe the present invention, a part that does not have a direct relationship with the description is omitted, but in implementing a device or system in which the spirit of the present invention is applied, it does not mean that the configuration omitted as such is not required. Moreover, through this specification, the same or similar component is represented by the same reference numeral.

In the following description, terms including first, second, and the like are used for describing various constituent elements, but the constituent elements are not limited by the terms and the terms are used only for distinguishing one constituent element from other constituent elements. Further, in the following description, a singular form may include a plural form if there is no clearly opposite meaning in the context.

In the following description, it should be understood that a term “include” or “have” indicates that a feature, a number, a step, an operation, a component, a part, or the combination thereof described in the specification is present, but does not exclude a possibility of presence or addition of one or more other features, numbers, steps, operations, components, parts or combinations thereof, in advance.

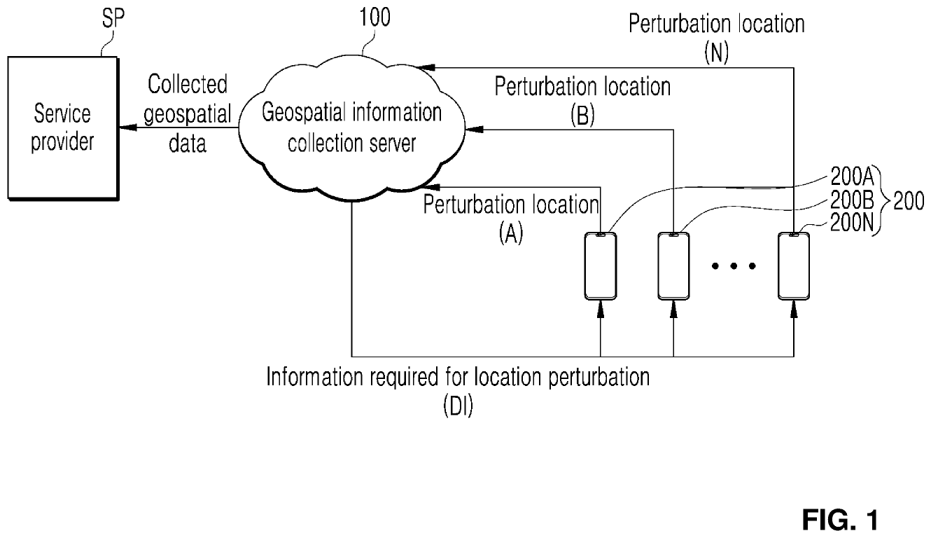

FIG. 1 is a diagram for schematically describing a geospatial information collection server 100 which collects a perturbed location corresponding to an original location from a plurality of geospatial information providing terminals 200A to 200N (200) according to an embodiment of the present invention.

Here, original locations of the plurality of geospatial information providing terminals 200A to 200N (200) may be an actual or current location of the relevant terminal, and may be an actual or current location of a user who possesses the relevant terminal.

Further, the perturbed location may be a transformed/distorted location for the purpose of privacy protection so as to prevent the original location from being accurately specified, and transformed/distorted within a range to satisfy a local differential privacy.

Since the geospatial information collection server 100 collects only the perturbed locations of the plurality of geospatial information providing terminals 200A to 200N (200) and does not directly collect the original location, a personal privacy may be protected regardless of a privacy protection policy of the server.

The geospatial information collection server 100 may provide information DI required for the location perturbation to the plurality of geospatial information providing terminals 200A to 200N (200). Here, the information DI required for the location perturbation may include information on a domain region in which all the original locations and the perturbed locations of the plurality of geospatial information providing terminals 200A to 200N (200) can be mapped, various parameter information for perturbation, and the like, and detailed contents will be described below.

The plurality of geospatial information providing terminals 200A to 200N (200) may receive the information D1 required for the location perturbation from the geospatial information collection server 100, generate perturbed locations A to N corresponding to the original locations, and provide the perturbed locations to the geospatial information collection server 100.

The geospatial information collection server 100 may provide collected geospatial data to a server provider SP.

Here, the geospatial data may include perturbed location information collected from the terminal, a reference region parameter, and domain region information of the terminal which is a target of location collection, but the embodiment is not limited thereto.

Since the service provider SP may receive geospatial data in which an error rate between the original location and the perturbed location is low, the service provider SP may effectively perform a personalized service having enhanced reliability.

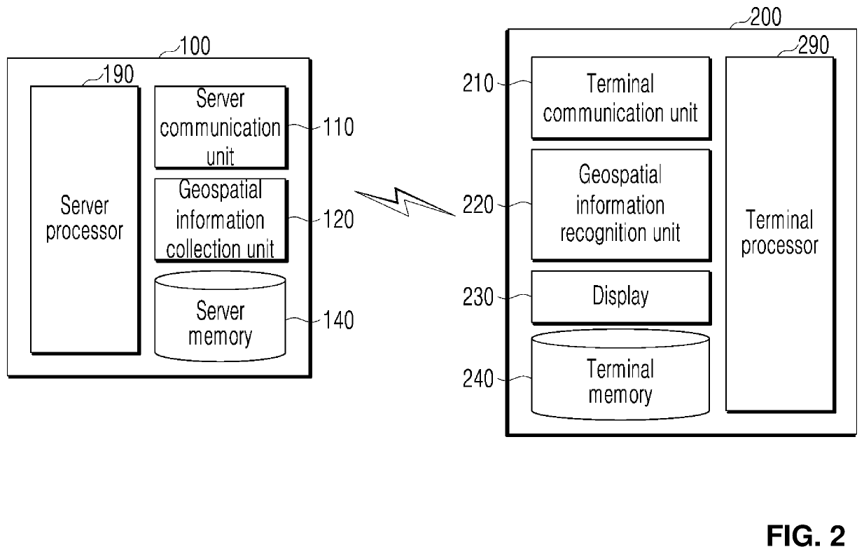

FIG. 2 is a relative block diagram illustrating a configuration of a geospatial information collection server 100 and a geospatial information providing terminal 200 according to an embodiment of the present invention.

The geospatial information collection server 100 may be implemented as an apparatus, a device, a cloud-based system, and a server system, but the embodiment is not limited thereto. The geospatial information collection server 100 may collect the perturbed location corresponding to the original location of the geospatial information providing terminal 200 from the geospatial information providing terminal 200.

The geospatial information collection server 100 may include a server communication unit 110, a geospatial information collection unit 120, a server memory 140, and one or more server processors 190, but may be implemented to include more components or less components therethan.

The server communication unit 110 as a module for communicating with various devices including the geospatial information providing terminal 200 may include a mobile communication module, a short-range communication module, etc.

The server processor 190 may provide various pieces of information to the geospatial information providing terminal 200 or receive various pieces of information from the geospatial information providing terminal 200 through the server communication unit 110.

The geospatial information collection unit 120 may collect the perturbed location corresponding to the original location of each geospatial information providing terminal 200 from at least one geospatial information providing terminal 200 according to the control of the server processor 190 through the server communication unit 110.

The server memory 140 may be a component capable of storing various pieces of information, and may store the perturbed location collected by the geospatial information collection unit 120. The server memory 140 may store a program including a series of codes or commands which allow the geospatial information collection server 100 to perform a geospatial information collection operation according to the embodiment, and input/output data accompanied thereby to be read/written by the server processor 190.

The server processor 190 may be implemented by one or more processors, and even though the server processor 190 is expressed as a single number, the server processor 190 may be regarded as a plural number. The server processor 190 may be a module for controlling respective components of the geospatial information collection server 100, and the server processor 190 may mean, for example, a data processing device embedded in hardware, which has a physically structured circuit in order to perform a function expressed by a code or a command included in the program. An example of the data processing device embedded in the hardware may include a processing device such as a microprocessor, a central processing unit (CPU), a processor core, a multiprocessor, an application-specific integrated circuit (ASIC), a field programmable gate array (FPGA), or a graphics processing unit (GPU), but the scope of the present invention is not limited thereto. The server processor 190 may separately include a learning processor for performing an artificial intelligence operation or autonomously include the learning processor therein.

Next, the geospatial information providing terminal 200 may include a terminal communication unit 210, a location recognition module 220, a display 230, a terminal memory 240, and a terminal processor 290, but include more components or less components therethan.

The terminal communication unit 210 as a module for communicating with various devices including the geospatial information collection server 100 may include the mobile communication module, the short-range communication module, etc.

The geospatial information recognition unit 220 may recognize the original location of the geospatial information providing terminal 200 by using various sensors and artificial satellite-based information (e.g., GPS information). For example, the geospatial information recognition unit 220 may recognize geospatial information including a current latitude and a current longitude of the geospatial information providing terminal 200 as the original location.

The display 230 may be a module for visually expressing various pieces of information, and may be implemented as a display using a backlight or a self-emitting display.

The terminal memory 240 may store various pieces of information, and store a program for implementing an algorithm for transforming/distorting the original location to the perturbed location. Further, the terminal memory 240 may store a program including a series of codes or commands which allow the geospatial information providing terminal 200 to perform a geospatial information providing operation according to the embodiment, and input/output data accompanied thereby to be read/written by the terminal processor 290.

The terminal processor 290 may be implemented by one or more processors, and even though the terminal processor 290 is expressed as a single number, the terminal processor 290 may be regarded as a plural number. The terminal processor 290 may be a module for controlling respective components of the geospatial information providing terminal 200, and the terminal processor 290 may mean, for example, a data processing device embedded in hardware, which has a physically structured circuit in order to perform a function expressed by a code or a command included in the program. An example of the data processing device embedded in the hardware may include a processing device such as a microprocessor, a central processing unit (CPU), a processor core, a multiprocessor, an application-specific integrated circuit (ASIC), a field programmable gate array (FPGA), or a graphics processing unit (GPU), but the scope of the present invention is not limited thereto. The terminal processor 290 may separately include a learning processor for performing an artificial intelligence operation or autonomously include the learning processor therein.

As described above, the configurations of the geospatial information collection server 100 and the geospatial information providing terminal 200 are described, and hereinafter, functions and operations of the geospatial information collection server 100 and the geospatial information providing terminal 200 will be primarily described.

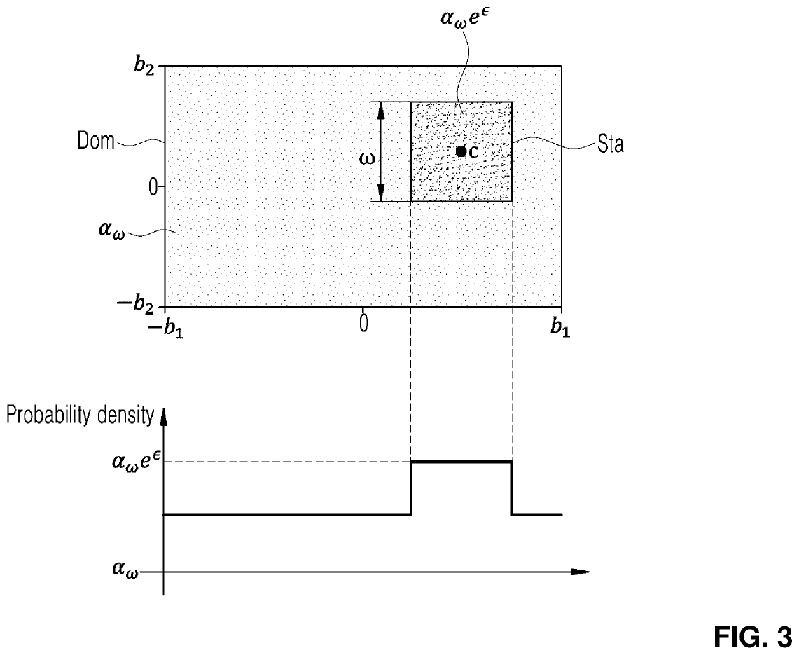

FIG. 3 is a diagram for describing an operation of a geospatial information collection server 100 which determines a domain region and sets a probability density in the domain region according to an embodiment of the present invention.

The server processor 190 may determine a domain region Dom for the original location of the geospatial information providing terminal 200, and even though the server processor 190 may not accurately recognize the original location, the server processor 190 may determine a sufficient region including the original location of the geospatial information providing terminal 200 as the domain region Dom. Here, it may be assumed that the original location of the geospatial information providing terminal 200 is uniformly distributed in the domain region Dom. The domain region Dom as a region including both the original location and the perturbed location of the geospatial information providing terminal 200 may be expressed on a 2D plane. An X-axis direction range of the domain region may be expressed from −b₁ to b₁, and a Y-axis direction range may be expressed from −b₂ to b₂. Here, b₁ and b₂ are positive real numbers larger than 0.

A predetermined reference region Sta for the original location of the geospatial information providing terminal 200 may be disposed inside the domain region Dom, and the reference region Sta may be implemented as a square having a one-side length of w, but the embodiment is not limited thereto. Here, w may be referred to as a region parameter of the reference region Sta. Here, w is a positive real number larger than 0.

Here, the location of the geospatial information providing terminal 200, i.e., the original location and the perturbed location may each include the latitude and the longitude, and may be mapped onto the domain region Dom. That is, the perturbed location generated by perturbing the original location of the geospatial information providing terminal 200 is not prevented from deviating from the domain region Dom, the utility and the reliability of the perturbed location collected from the geospatial information providing terminal 200 may be enhanced while achieving the privacy protection.

The server processor 190 may define a reference probability for sampling the perturbed location in the domain region Dom according to a relationship between the reference region Sta in the domain region Dom and the perturbed location for the original location of the geospatial information providing terminal 200, and the reference probability is shown as in [Equation 1] below.

$$Pr [ {f}_{S} ( p ) = \tilde{p} ] = \{ \begin{matrix}{α}_{w} \cdot {e}^{ϵ} , & if \tilde{p} ∈ Sta \\ {α}_{w} , & otherwise\end{matrix} \qquad [ Equation 1 ]$$

The reference probability Pr is a probability for defining a sampling reference of a sampling function ƒₛ of sampling a random variable. By the reference probability Pr, when sampling a perturbed location \tilde{p} based on an original location p, the sampling function ƒₛ may sample the perturbed location \tilde{p} with a probability density of α_{w}·e^{ε} if the perturbed location \tilde{p} is within the reference region Sta and sample the perturbed location \tilde{p} with a probability density of α_{w} if the perturbed location \tilde{p} is out of the reference region Sta. However, the server processor 190 may not recognize center information of the original location P and the reference region Sta corresponding to the original location P. That is, the server processor 190 may define the reference probability Pr by assuming that the original location p is uniformly distributed in the domain region Dom.

The reference probability Pr may be expressed as a probability density or a probability density function for the perturbed location, and may include a first reference probability α_{w}·e^{ε} for a case where the perturbed location is within the reference region Sta and a second reference probability α_{w} for a case where the perturbed location is within the domain region Dom out of the reference region Sta.

Here, the first reference probability α_{w}·e^{ε} may be defined to sample the perturbed location with a higher probability than the second reference probability α_{w}.

The reference probability Pr may be defined based on a sampling parameter α_{w} defined based on the domain region Dom, the reference region Sta, and a privacy parameter ε, and the sampling parameter α_{w} may be defined by [Equation 2] below.

α_{w}=1/(w²(e^{ε}−1)+4b₁b₂) [Equation 2]

Here, the privacy parameter ε as a parameter for adjusting a trade-off between a privacy protection level and the utility of the collected data may be a parameter for satisfying the local differential privacy.

The server processor 190 may transmit the region parameter w of the determined reference region Sta to at least one terminal 200 which is the target of the location collection through the server communication unit 110.

Moreover, the server processor 190 may provide the perturbed location collected by the geospatial information collection unit 120 to the service provider SP through the server communication unit 110.

The server processor 190 may define a relation equation for setting a center c in the reference region Sta while not recognizing the center c in the reference region Sta, arrange the center c maximally close to the original location, set the reference region Sta not to deviate from the domain region Dom, and define a relation equation of setting the center c for minimizing the error between the original location and the perturbed location based on [Equation 3] below. Here, d may represent a 1 dimension (X axis) and a 2 dimension (Y axis).

$$c [ d ] = \{ \begin{matrix}- {b}_{d} + w / 2 & if p [ d ] \leq - {b}_{d} + w / 2 , \\ p [ d ] & if - {b}_{d} + w / 2 \leq p [ d ] \leq {b}_{d} - w / 2 , \\ {b}_{d} - w / 2 & otherwise\end{matrix} . \qquad [ Equation 3 ]$$

When the center c of the reference region Sta is determined, the server processor 190 may derive an expected value of the error between the original location and the perturbed location based on the reference probability Pr.

In a situation in which the original location p is uniformly distributed in the domain region Dom, the server processor 190 may calculate an expected value of a mean square error (MSE) of the perturbed location \tilde{p} as in [Equation 4] below after the center c is determined.

E┌MSE(\tilde{p},p)┘=α_{w}·4b₁b₂(b₁²+b₂²)/3+α_{w}·w⁴(e^{ε}−1)/12+α_{w}·w⁵)e^{ε}−1)(b₁+b₂)/(48b₁b₂), [Equation 4]

In this case, the region parameter w for minimizing the expected value of the mean square error (MSE) may be derived by [Equation 5] below.

$$\begin{matrix}minimize & 𝔼 [ MSE ( \tilde{p} , p ) ] \\ subject to & 0 < w < 2 \cdot min ( {b}_{1} , {b}_{2} )\end{matrix} . \qquad [ Equation 5 ]$$

The server processor 190 may determine the region parameter w of the reference region Sta so as to minimize the expected value based on the original location p uniformly distributed in the domain Dom.

An optimal region parameter w may be expressed as w [symbol] , and the determined reference region Sta may be expressed as C*(p), and the sampling parameter α_{w} may be expressed as α*.

According to an embodiment of the present invention, as described above, the perturbed location corresponding to the original location may be generated with high accuracy and reliability by using a 2-dimensional joint probability distribution.

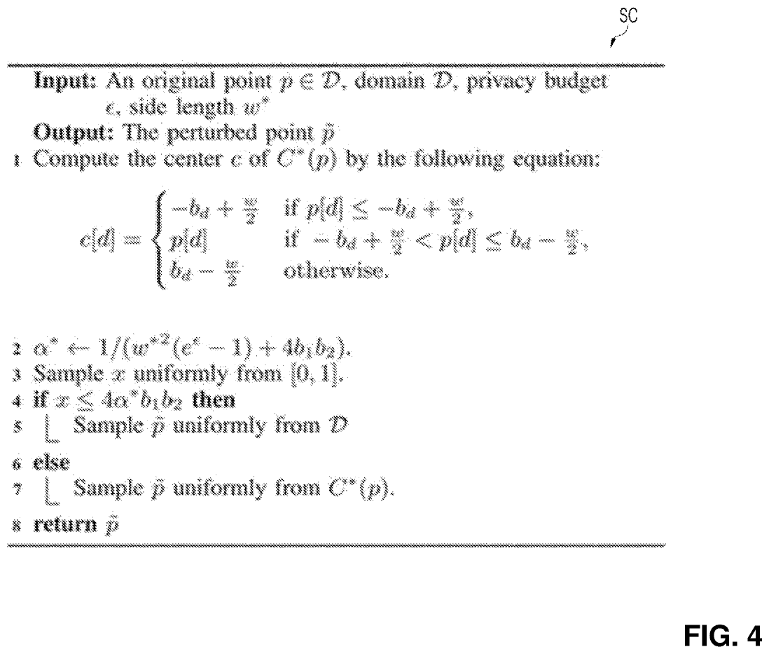

FIG. 4 illustrates an algorithm SC for describing a geospatial information providing terminal 200 which samples a perturbed location based on an original location according to an embodiment of the present invention.

First, the terminal processor 290 may obtain the region parameter w* of a reference region C*(p) within a domain region [symbol] for the original location p of the terminal 200 from the geospatial information collection server 100 through the terminal communication unit 110. The terminal processor 290 may also receive the domain region [symbol] and the privacy parameter ϵ through the terminal communication unit 210.

In Line 1 of the algorithm SC, the terminal processor 290 may determine the center c of the reference region C*(p) so that the reference region C*(p) is positioned within the domain region [symbol] based on the original location p. Specifically, the terminal processor 290 may determine the center c so that the reference region C*(p) including the original location p deviates the domain region [symbol] for each dimension (X axis and Y axis).

In Line 2 of the algorithm SC, the terminal processor 290 may calculate a sampling reference parameter α*.

In Lines 3 to 7 of the algorithm SC, the terminal processor 290 may sample a perturbed location \tilde{p} from the domain region D or the reference region C*(p) based on a sampling value x determined in a predetermined probability range. Here, the probability range is a sample space of the sampling value x, and the sampling value x is a value sampled from a section of [0, 1] uniformly distributed.

Specifically, the terminal processor 290 may determine the sampling reference parameter α* based on the region parameter w* and the domain region [symbol] , and determine a region to sample the perturbed location \tilde{p} according to a comparison result of a reference value 4α*b₁b₂ determined based on the domain region [symbol] and the sampling reference parameter α*, and the determined sampling value x. The region to sample the perturbed location is the domain region [symbol] or the reference region C*(p).

Specifically, in Lines 4 and 5 of the algorithm SC, when the sampling value x is smaller than the reference value 4α*b₁b₂, the terminal processor 290 samples the perturbed location \tilde{p} according to the uniform distribution in the domain region [symbol] .

In Lines 6 and 7 of the algorithm SC, when the sampling value x is larger than the reference value 4α*b₁b₂, the terminal processor 290 samples the perturbed location \tilde{p} according to the uniform distribution in the reference region C*(p).

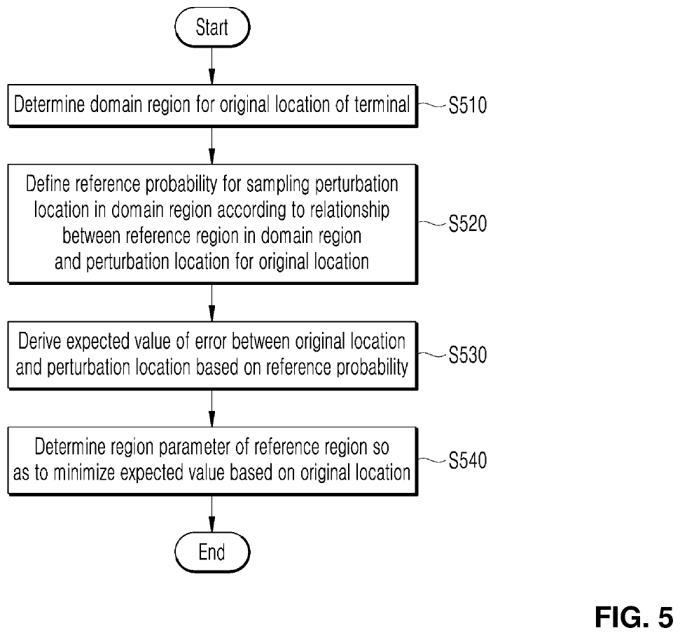

FIG. 5 is a sequence diagram illustrating a geospatial information collection method of a geospatial information collection server 100 according to an embodiment of the present invention.

The geospatial information collection server 100 determines a domain region for an original location of a terminal (S510).

The geospatial information collection server 100 defines a reference probability for sampling a perturbed location in the domain region according to a relationship between a reference region in the domain region and the perturbed location for the original location (S520).

Each of the original location and the perturbed location may include a latitude and a longitude, and may be mapped on the domain region.

Thereafter, the geospatial information collection server 100 derives an expected value of an error between the original location and the perturbed location based on the reference probability (S530).

Thereafter, the geospatial information collection server 100 determines a region parameter of the reference region so as to minimize the expected value based on the original location (S540).

Here, the reference probability may be defined based on a sampling parameter α_{w} defined based on the domain region, the reference region, and a privacy parameter. The reference region may be a square region, and the region parameter of the reference region may include a square side length, but a shape of the reference region is not limited to a square shape.

Further, the reference probability may be a probability density function for the perturbed location, and may include a first reference probability for a case where the perturbed location is within the reference region and a second reference probability for a case where the perturbed location is within the domain region out of the reference region.

Further, the first reference probability may be defined to sample the perturbed location with a higher probability than the second reference probability.

The geospatial information collection server 100 may transmit the region parameter of the determined reference region to at least one terminal which is the target of the location collection.

The geospatial information collection server 100 may collect the perturbed location corresponding to the original location from at least one terminal, and provide the collected perturbed location to the service provider.

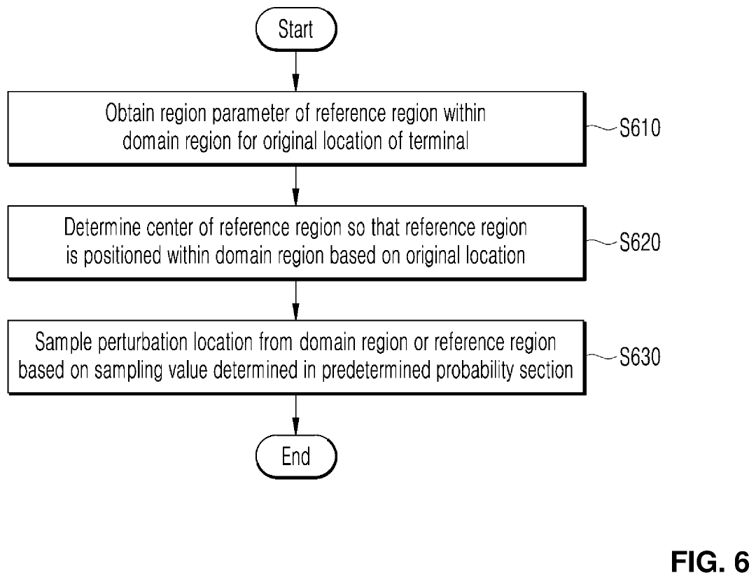

FIG. 6 is a sequence diagram illustrating a geospatial information providing method of a geospatial information providing terminal 200 according to an embodiment of the present invention.

The geospatial information providing terminal 200 obtains a region parameter of the reference region within the domain region for the original location of the terminal (S610).

Next, the geospatial information providing terminal 200 determines a center of the reference region so that the reference region is positioned within the domain region based on the original location (S620).

Thereafter, the geospatial information providing terminal 200 samples a perturbed location from the domain region or the reference region based on a sampling value determined in a predetermined probability range (S630).

In step S630 above, the geospatial information providing terminal 200 may determine a sampling reference parameter based on the region parameter and the domain region, and determine a region to sample the perturbed location according to a comparison result of a reference value determined based on the domain region and the sampling reference parameter, and the determined sampling value.

The geospatial information collection method and the geospatial information providing method according to an embodiment of the present invention described above can be embodied as computer readable codes on a medium in which a program is recorded. The computer readable medium includes all kinds of recording devices storing data which may be deciphered by a computer system. Examples of the computer readable medium may include a hard disk drive (HDD), a solid state disk (SSD), a silicon disk drive (SDD), a ROM, a RAM, a CD-ROM, a magnetic tape, a floppy disk, an optical data storage device, and the like.

The aforementioned description of the embodiment of the present invention is used for exemplification, and it can be understood by those skilled in the art that the present invention can be easily modified in other detailed forms without changing the technical spirit or requisite features of the present invention. Therefore, it should be appreciated that the aforementioned embodiments are illustrative in all aspects and are not restricted. For example, respective constituent elements described as single types can be distributed and implemented, and similarly, constituent elements described to be distributed can also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

1. A method for collecting geospatial information, the method comprising:
determining a domain region for an original location of a terminal;
defining a reference probability for sampling a perturbed location in the domain region according to a relationship between a reference region in the domain region and the perturbed location for the original location;
deriving an expected value of an error between the original location and the perturbed location based on the reference probability; and
determining a region parameter of the reference region so as to minimize the expected value.

2. The method of claim 1, wherein the reference probability is defined based on a sampling parameter α_{w} defined based on the domain region, the reference region, and a privacy parameter.

3. The method of claim 1, wherein the reference probability is a probability for the perturbed location, and includes a first reference probability for a case where the perturbed location is within the reference region and a second reference probability for a case where the perturbed location is within the domain region out of the reference region.

4. The method of claim 1, further comprising:
transmitting the region parameter of the determined reference region to at least one terminal which is a target of location collection.

5. The method of claim 1, wherein the reference region may be a square region, and the region parameter of the reference region includes a square side length.

6. The method of claim 3, wherein the first reference probability is defined to sample the perturbed location with a higher probability than the second reference probability.

7. The method of claim 1, wherein each of the original location and the perturbed location includes a latitude and a longitude, and is mapped on the domain region.

8. The method of claim 4, further comprising:
collecting the perturbed location corresponding to the original location of each terminal from at least one terminal; and
providing the collected perturbed location to a service provider.

9. A method for providing geospatial information, the method comprising:
obtaining a region parameter of a reference region within a domain region for an original location of a terminal;
determining a center of the reference region so that the reference region is positioned within the domain region based on the original location; and
sampling a perturbed location from the domain region or the reference region based on a sampling value determined in a predetermined probability range.

10. The method of claim 9, wherein the sampling of the perturbed location includes
determining a sampling reference parameter based on the region parameter and the domain region, and
determining a region to sample the perturbed location according to a comparison result of a reference value determined based on the domain region and the sampling reference parameter, and the determined sampling value.

11. A server for collecting geospatial information, the server comprising:
one or more server processors determining a domain region for an original location of a terminal, and defining a reference probability for sampling a perturbed location in the domain region according to a relationship between a reference region in the domain region and the perturbed location for the original location,
wherein the server processor is configured to derive an expected value of an error between the original location and the perturbed location based on the reference probability, and determine a region parameter of the reference region so as to minimize the expected value.

12. The server of claim 11, wherein the reference probability is defined based on a sampling parameter α_{w} defined based on the domain region, the reference region, and a privacy parameter.

13. The server of claim 11, wherein the reference probability is a probability for the perturbed location, and includes a first reference probability for a case where the perturbed location is within the reference region and a second reference probability for a case where the perturbed location is within the domain region out of the reference region.

14. The server of claim 11, further comprising:
a server communication unit,
wherein the server processor is configured to transmit the region parameter of the determined reference region to at least one terminal which is a target of location collection through the server communication unit.

15. The server of claim 11, wherein the reference region may be a square region, and the region parameter of the reference region includes a square side length.

16. The server of claim 13, wherein the first reference probability is defined to sample the perturbed location with a higher probability than the second reference probability.

17. The server of claim 11, wherein each of the original location and the perturbed location includes a latitude and a longitude, and is mapped on the domain region.

18. The server of claim 14, further comprising:
a geospatial information collection unit collecting the perturbed location corresponding to the original location from at least one terminal through the server communication unit,
wherein the server processor is configured to provide the perturbed location collected by the geospatial information collection unit to a service provider through the server communication unit.

19. A terminal for providing geospatial information, the terminal comprising:
a terminal communication unit; and
one or more terminal processors obtaining a region parameter of a reference region within a domain region for an original location of a terminal from a geospatial information collection server through terminal communication unit, and determining a center of the reference region so that the reference region is positioned within the domain region based on the original location,
wherein the terminal processor is configured to sample a perturbed location from the domain region or the reference region based on a sampling value determined in a predetermined probability range.

20. The terminal of claim 19, wherein the terminal processor is configured to determine a sampling reference parameter based on the region parameter and the domain region, and determining a region to sample the perturbed location according to a comparison result of a reference value determined based on the domain region and the sampling reference parameter, and the determined sampling value.
